(19) United States
(12) Patent Application Publication
(10) Pub. No.: US 2021/0099018 A1
(43) Pub. Date: Apr. 1, 2021

(54) NON-CONTACT POWER FEEDING APPARATUS

(71) Applicant: OMRON Corporation, Kyoto-shi (JP)

(72) Inventor: Kenichi TABATA, Ichinomiya-shi (JP)

(73) Assignee: OMRON Corporation, Kyoto-shi (JP)

(21) Appl. No.: 16/994,713

(22) Filed: Aug. 17, 2020

(30) Foreign Application Priority Data
Sep. 27, 2019 (JP) 2019-177895

(51) Int. Cl. H02J 50/12; H04B 5/00; H01F 38/14

(52) U.S. Cl. CPC H02J 50/12; H01F 38/14; H04B 5/0081; H04B 5/0037

(57) ABSTRACT

A non-contact power feeding apparatus may suppress a variation in power transmission efficiency due to a change in the positional relationship between a power transmission side and a power reception side of an apparatus. A power transmission apparatus of a non-contact power feeding apparatus may include a transmission coil that transmits AC power to a power reception apparatus in a non-contact manner, and a power supply circuit that supplies AC power to the transmission coil. The power reception apparatus may include a reception coil that receives AC power from the transmission coil. The transmission coil and the reception coil may be formed such that the size of one of the transmission coil and the reception coil in a plane orthogonal to a winding axis thereof is larger than the size of the other of the transmission coil and the reception coil in a plane orthogonal to a winding axis thereof.

### CROSS-REFERENCES TO RELATED APPLICATIONS

This application claims priority to Japanese Patent Application No. 2019-177895 filed Sep. 27, 2019, the entire contents of which are incorporated herein by reference.

### FIELD

The disclosed embodiments relate to a non-contact power feeding apparatus.

### BACKGROUND

Conventionally, research has been conducted on so-called non-contact power feeding (also referred to as “wireless power feeding”) technique of transmitting power through a space without using metal contacts or the like.

As one of such non-contact power feeding techniques, a method is known in which electric power is transmitted from the primary side (power transmission side or power feeding side) to the secondary side (power reception side) by magnetic field resonance between the primary side coil and the secondary side coil. In such a power transmitting system using magnetic field resonance, a technique is known in which a magnetic body is disposed on the side opposite to the power reception coil when viewed from the power transmission coil, and a magnetic body is disposed on the side opposite to the power transmission coil when viewed from the power reception coil (see JP 2010-239848A, for example). In this technique, the magnetic field of the power transmission coil and the magnetic field of the power reception coil can be provided with directivity by the arrangement of the magnetic bodies. As a result, the degree of coupling of the magnetic fields between the power transmission coil and the power reception coil is increased, and the power transmission efficiency is improved.

JP 2010-239848A is an example of a background art.

### SUMMARY

However, the positional relationship between the apparatus on the power transmission side and the apparatus on the power reception side may not be constant. In such a case, the degree of coupling between the power transmission-side coil and the power reception-side coil also changes in accordance with a change in the positional relationship between the power transmission-side apparatus and the power-reception side apparatus. As a result, the power transmission efficiency also changes.

Disclosed aspects aim to provide a non-contact power feeding apparatus capable of suppressing a variation in power transmission efficiency due to changes in the positional relationship between an apparatus on a power transmission side and an apparatus on a power reception side.

According to one or more aspects, a non-contact power feeding apparatus including a power transmission apparatus and a power reception apparatus to which power is transmitted from the power transmission apparatus in a non-contact manner is provided. In the non-contact power feeding apparatus, the power transmission apparatus includes a transmission coil configured to transmit alternating-current (AC) power to the power reception apparatus in a non-contact manner, and a power supply circuit configured to supply AC power to the transmission coil. On the other hand, the power reception apparatus includes a resonance circuit including a reception coil configured to receive AC power from the transmission coil. The transmission coil and the reception coil are formed such that the size of one of the transmission coil and the reception coil in a plane orthogonal to a winding axis thereof is larger than the size of the other of the transmission coil and the reception coil in a plane orthogonal to a winding axis thereof. With such a configuration, the non-contact power feeding apparatus can suppress a variation in power transmission efficiency due to a change in the positional relationship between the apparatus on the power transmission side and the apparatus on the power reception side.

In the non-contact power feeding apparatus, it is preferable that the transmission coil and the reception coil are formed such that an inner diameter of one of the transmission coil and the reception coil in a plane orthogonal to a winding axis thereof is larger than an outer diameter of the other of the transmission coil and the reception coil in a plane orthogonal to a winding axis thereof. With this configuration, the non-contact power feeding apparatus can further suppress a change in the degree of coupling between the transmission coil and the reception coil due to a change in the positional relationship between the transmission coil and the reception coil.

Accordingly, the non-contact power feeding apparatus can further suppress a variation in power transmission efficiency due to a change in the positional relationship between the apparatus on the power transmission side and the apparatus on the power reception side.

In the non-contact power feeding apparatus, it is preferable that the power supply circuit of the power transmission apparatus includes an inverter circuit including a plurality of switching elements connected in a full-bridge configuration or a half-bridge configuration between a direct-current (DC) power supply and the transmission coil, and that the power supply circuit is configured to convert DC power supplied from the DC power supply into AC power having a frequency at which the resonance circuit of the power reception apparatus resonates by switching on and off of the plurality of switching elements at that frequency, and supplies the AC power to the transmission coil. Then, it is preferable that the power transmission apparatus further includes a phase adjustment circuit configured to adjust a delay amount of a phase of a current flowing through the plurality of switching elements of the inverter circuit with respect to a phase of a voltage applied to the plurality of switching elements. With this configuration, the non-contact power feeding apparatus can suppress the switching loss of the switching elements of the inverter circuit and improve the power transmission efficiency without adjusting the switching frequency according to a change in the degree of coupling between the transmission coil and the reception coil.

### BRIEF DESCRIPTION OF THE DRAWINGS

FIG. 1 is a schematic configuration diagram illustrating a non-contact power feeding apparatus according to one or more embodiments.

FIG. 2 is a schematic side view illustrating a transmission coil and a reception coil, showing a comparison of the size of the transmission coil and the reception coil.

FIG. 3 is a diagram illustrating an example of a relationship between a relative position of a reception coil with respect to a transmission coil and a degree of coupling between the transmission coil and the reception coil according to a comparative example.

FIG. 4 is a diagram illustrating an example of a relationship between a relative position of a reception coil with respect to a transmission coil and a degree of coupling between the transmission coil and the reception coil according to one or more embodiments.

FIG. 5 is a diagram illustrating another example of a relationship between a relative position of a reception coil with respect to a transmission coil and a degree of coupling between the transmission coil and the reception coil according to one or more embodiments.

FIG. 6 is a diagram illustrating an example of a relationship between a relative position of a reception coil with respect to a transmission coil and a degree of coupling between the transmission coil and the reception coil according to one or more modifications.

### DETAILED DESCRIPTION

Hereinafter, a non-contact power feeding apparatus according to one or more embodiments will be described with reference to the drawings. In the non-contact power feeding apparatus according to one or more embodiments, the size of one of a power transmission coil (hereinafter referred to as a transmission coil) included in an apparatus on a power transmission side (hereinafter simply referred to as a power transmission apparatus) and a power reception coil (hereinafter referred to as a reception coil) included in an apparatus on a power reception side (hereinafter referred to as a power reception apparatus) in a plane orthogonal to a winding axis thereof is made larger than the size of the other coil in a plane orthogonal to a winding axis thereof. With this configuration, a change in the amount of interlinkage flux emitted from the transmission coil and passing through the reception coil when the positional relationship between the transmission coil and the reception coil changes is suppressed.

Because the amount of interlinkage flux affects the degree of coupling between the transmission coil and the reception coil, a change in the degree of coupling between the transmission coil and the reception coil is suppressed by suppressing a change in the amount of interlinkage flux. As a result, the non-contact power feeding apparatus can suppress a variation in power transmission efficiency due to a change in the positional relationship between the power transmission apparatus and the power reception apparatus.

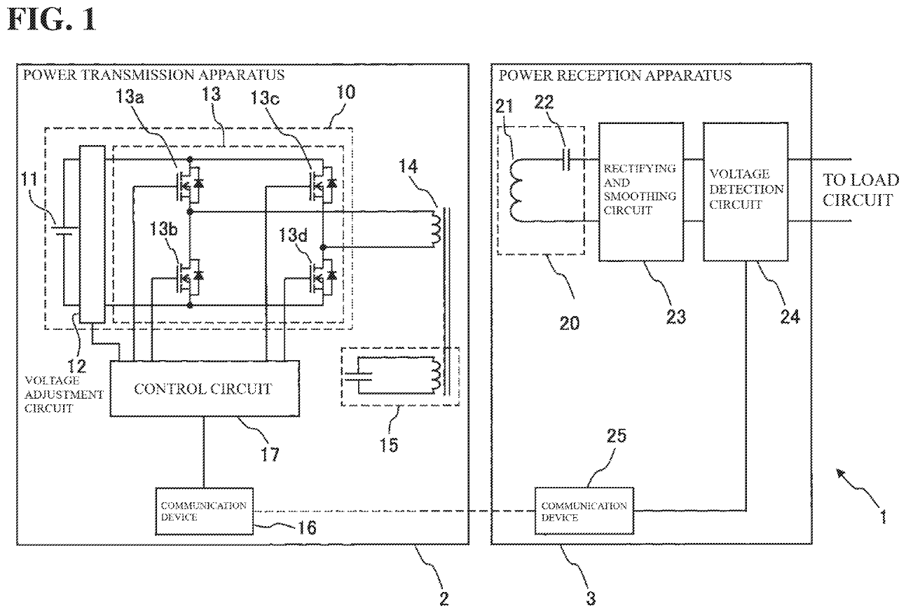

FIG. 1 is a schematic configuration diagram of a non-contact power feeding apparatus including a power transmission apparatus according to one or more embodiments. As shown in FIG. 1, a non-contact power feeding apparatus 1 includes a power transmission apparatus 2, and a power reception apparatus 3 to which power is transmitted in a non-contact manner from the power transmission apparatus 2 via a space. The power transmission apparatus 2 includes a power supply circuit 10, a transmission coil 14, a phase adjustment circuit 15, a communication device 16, and a control circuit 17. On the other hand, the power reception apparatus 3 includes a resonance circuit 20 including a reception coil 21 and a resonance capacitor 22, a rectifying and smoothing circuit 23, a voltage detection circuit 24, and a communication device 25. The non-contact power feeding apparatus 1 according to the present embodiment does not use resonance on the power transmission side, and transmits power in accordance with a scheme (NS scheme) in which the resonance circuit 20 on the power reception side performs series resonance with respect to AC power supplied to the transmission coil 14. Note, that the non-contact power feeding apparatus 1 may also transmit power in accordance with a scheme (NP scheme) in which the resonance circuit 20 on the power reception side performs parallel resonance with respect to AC power supplied to the transmission coil 14, without using resonance on the power transmission side.

First, the power transmission apparatus 2 will be described. The power supply circuit 10 supplies AC power to the transmission coil 14. For this purpose, the power supply circuit 10 includes a power supply 11, a voltage adjustment circuit 12, and an inverter circuit 13.

The power supply 11 supplies DC power. For this purpose, for example, the power supply 11 is connected to a commercial AC power supply, and includes a full-wave rectifier circuit for rectifying AC power supplied from the AC power supply and a smoothing capacitor for smoothing pulsating power that is output from the full-wave rectifier circuit. Then, the power supply 11 converts the AC power supplied from the commercial AC power supply into DC power, and outputs the converted DC power to the voltage adjustment circuit 12. Note, that the power supply 11 may also be a DC power supply such as a battery.

The voltage adjustment circuit 12 adjusts the voltage of the DC power supplied from the power supply 11 under the control of the control circuit 17, and supplies the DC power having the adjusted voltage to the inverter circuit 13. For this purpose, the voltage adjustment circuit 12 includes, for example, a step-down or step-up DC/DC converter, and a relay provided on a power line that bypasses the DC/DC converter. The control circuit 17 can control the voltage that is output from the voltage adjustment circuit 12 by switching on or off the relay.

Note, that the power supply 11 and the voltage adjustment circuit 12 may also be configured as a single variable voltage power supply. In this case, the variable voltage power supply may also include, for example, a power factor improvement circuit for improving the power factor of AC power supplied from the AC power supply, and a DC/DC converter for converting the voltage of DC power that is output from the power factor improvement circuit. The control circuit 17 can control the voltage that is output from the voltage adjustment circuit 12 by controlling the degree of improvement of the power factor by the power factor improvement circuit.

The inverter circuit 13 converts the DC power supplied from the voltage adjustment circuit 12 into AC power having a predetermined frequency, and supplies the converted AC power to the transmission coil 14. The predetermined frequency may be a frequency at which the resonance circuit 20 of the power reception apparatus 3 resonates at an assumed degree of coupling between the transmission coil 14 and the reception coil 21. In the present embodiment, the inverter circuit 13 is a full-bridge inverter in which four switching elements 13a to 13d are connected in a full-bridge configuration. Each switching element may be, for example, an n-channel MOSFET.

That is to say, the switching element 13a and the switching element 13b of the four switching elements 13a to 13d are connected in series between the positive electrode side terminal and the negative electrode side terminal of the voltage adjustment circuit 12. In the present embodiment, the switching element 13a is connected to the positive electrode side of the voltage adjustment circuit 12, and the switching element 13b is connected to the negative electrode side of the voltage adjustment circuit 12. Similarly, the switching element 13c and the switching element 13d of the four switching elements 13a to 13d are connected in parallel to the switching element 13a and the switching element 13b, and in series between the positive electrode side terminal and the negative electrode side terminal of the voltage adjustment circuit 12. Also, the switching element 13c is connected to the positive electrode side of the voltage adjustment circuit 12, and the switching element 13d is connected to the negative electrode side of the voltage adjustment circuit 12. One end of the transmission coil 14 is connected to the node between the switching element 13a and the switching element 13b, and the other end of the transmission coil 14 is connected to the switching element 13c and the switching element 13d.

Note, that the inverter circuit 13 may also be a half-bridge inverter in which two switching elements are connected to the voltage adjustment circuit 12 in a half-bridge.

The transmission coil 14 transmits AC power supplied from the power supply circuit 10 to the reception coil 21 of the power reception apparatus 3 via a space. Note, that the power transmission apparatus 2 may also include a capacitor that is connected in series with the transmission coil 14 and cuts off DC power, between the transmission coil 14 and the inverter circuit 13 of the power supply circuit 10.

The phase adjustment circuit 15 reduces a switching loss caused by the switching elements of the inverter circuit 13 by setting a delay amount of a phase of a current flowing through the switching elements with respect to a phase of a voltage applied to the switching elements of the inverter circuit 13 to an appropriate delay amount. In this manner, even if the control circuit 17 does not adjust the frequency at which each switching element is switched on and off in accordance with a change in the degree of coupling between the transmission coil 14 and the reception coil 21, that is to say, the frequency of the AC power supplied to the transmission coil 14, the non-contact power feeding apparatus 1 can improve the power transmission efficiency.

The phase adjustment circuit 15 includes, for example, an auxiliary coil disposed to be electromagnetically coupled to the transmission coil 14, and a capacitor constituting an LC circuit together with the auxiliary coil. In this case, the auxiliary coil is wound around the same magnetic core as the transmission coil 14, for example. The number of turns of the auxiliary coil may also be the same as or different from the number of turns of the transmission coil 14.

In this case, the resonance frequency of the LC circuit constituted by the auxiliary coil and the capacitor may also be different from the frequency of the AC power supplied to the transmission coil 14. That is to say, the LC circuit constituted by the auxiliary coil and the capacitor does not have to resonate with the alternating current flowing through the transmission coil 14.

If the degree of coupling between the transmission coil 14 and the reception coil 21 is low, for example, if the power reception apparatus 3 is so far away from the power transmission apparatus 2 that power cannot be received, the phase of the current flowing through the transmission coil 14 is delayed from the phase of the voltage applied to the switching elements of the inverter circuit 13 of the power supply circuit 10. The same applies to a case where the current flowing through the load circuit that is connected to the power reception apparatus 3 is small. Accordingly, the inductance of the auxiliary coil and the capacitance of the capacitor are preferably set such that the phase of the current flowing through the LC circuit constituted by the auxiliary coil and the capacitor leads the phase of the voltage applied to the switching elements of the inverter circuit 13. For this purpose, the inductance of the auxiliary coil and the capacitance of the capacitor are preferably set such that the resonance frequency of the LC circuit is higher than the frequency of the AC power supplied to the transmission coil 14.

In a modification, the phase adjustment circuit 15 may also be an LC series circuit that is connected in parallel with the transmission coil 14, and that is constituted by a coil and a capacitor connected in series with the coil. Also in this case, the inductance of the coil and the capacitance of the capacitor included in the LC series circuit are preferably set such that the phase of the current flowing through the LC series circuit leads the phase of the voltage applied to the switching elements of the inverter circuit 13. Accordingly, the inductance of the coil and the capacitance of the capacitor are preferably set such that the resonance frequency of the LC series circuit is higher than the switching frequency of the AC power applied to the transmission coil 14.

Each time the communication device 16 receives a radio signal from the communication device 25 of the power reception apparatus 3, the communication device 16 extracts voltage information indicating a measured value of the output voltage from the radio signal, and outputs the voltage information to the control circuit 17. For this purpose, the communication device 16 includes, for example, an antenna that receives a radio signal in accordance with a predetermined radio communication standard and a communication circuit that demodulates the radio signal. The predetermined radio communication standard may be, for example, ISO/IEC 15693, ZigBee (registered trademark), or Bluetooth (registered trademark).

The control circuit 17 includes, for example, a non-volatile memory circuit and a volatile memory circuit, an arithmetic circuit, an interface circuit for connecting to another circuit, and a drive circuit for outputting control signals to the voltage adjustment circuit 12 of the power supply circuit 10 and the switching elements 13a to 13d of the inverter circuit 13. The control circuit 17 controls the switching elements 13a to 13d of the inverter circuit 13 such that the frequency of the AC power supplied from the power supply circuit 10 to the transmission coil 14 becomes a predetermined frequency. As described above, the predetermined frequency may be a frequency at which the resonance circuit 20 of the power reception apparatus 3 resonates at an assumed degree of coupling between the transmission coil 14 and the reception coil 21.

In the present embodiment, the control circuit 17 alternately turns on the pair of the switching element 13a and the switching element 13d and the pair of the switching element 13b and the switching element 13c. Furthermore, the control circuit 17 equalizes a period in which the pair of the switching element 13a and the switching element 13d is turned on and a period in which the pair of the switching element 13b and the switching element 13c is turned on in one cycle corresponding to the frequency of the AC power supplied to the transmission coil 14. The control circuit 17 preferably prevents the power supply 11 from being short-circuited due to the pair of the switching element 13a and the switching element 13d and the pair of the switching element 13b and the switching element 13c being turned on at the same time. For this purpose, when the control circuit 17 switches on/off the pair of the switching element 13a and the switching element 13d and the pair of the switching element 13b and the switching element 13c, a dead time may also be provided in which both pairs of the switching elements are turned off. If the inverter circuit 13 is a half-bridge inverter, the control circuit 17 may alternately turn on two switching elements at the frequency of the AC power supplied to the transmission coil 14.

Furthermore, the control circuit 17 controls the voltage adjustment circuit 12 so that the output voltage from the power reception apparatus 3 approaches the target voltage, based on the measured value of the output voltage indicated in the voltage information. That is to say, if the measured value of the output voltage is higher than the target voltage, the control circuit 17 controls the voltage adjustment circuit 12 to decrease the voltage that is output from the voltage adjustment circuit 12, and on the other hand, if the measured value of the output voltage is lower than the target voltage, the control circuit 17 controls the voltage adjustment circuit 12 to increase the voltage that is output from the voltage adjustment circuit 12. If the absolute value of the difference between the measured value of the output voltage and the target voltage falls within a predetermined allowable variation range, the control circuit 17 may also control the voltage adjustment circuit 12 so that the voltage that is output from the voltage adjustment circuit 12 is maintained as it is.

Next, the power reception apparatus 3 will be described. The reception coil 21 constitutes a resonance circuit 20 together with a resonance capacitor 22, and receives power from the transmission coil 14 by resonating with an alternating current flowing through the transmission coil 14 of the power transmission apparatus 2. In the present embodiment, the resonance capacitor 22 is connected in series with the reception coil 21, but the resonance capacitor 22 may also be connected in parallel with the reception coil 21. The resonance circuit 20 may also be provided with a coil connected in series with the reception coil 21 between the reception coil 21 and the rectifying and smoothing circuit 23. The AC power output from the resonance circuit 20 is converted into DC power by the rectifying and smoothing circuit 23, and then output to a load circuit (not shown) that is connected to the power reception apparatus 3. The number of turns of the reception coil 21 and the number of turns of the transmission coil 14 may also be the same or different from each other.

The rectifying and smoothing circuit 23 is an example of a rectifying circuit, and includes, for example, a full-wave rectifier circuit having four bridge-connected diodes, and a smoothing capacitor, and rectifies and smoothes the power output from the resonance circuit 20 to convert the power into DC power. Then, the rectifying and smoothing circuit 23 outputs the DC power to the load circuit.

The voltage detection circuit 24 measures an output voltage between the two terminals of the rectifying and smoothing circuit 23. Because the output voltage between the two terminals of the rectifying and smoothing circuit 23 directly corresponds to the output voltage of the resonance circuit 20, the measured value of the output voltage between the two terminals of the rectifying and smoothing circuit 23 is indirectly the measured value of the output voltage of the resonance circuit 20. The voltage detection circuit 24 may be, for example, any of various known voltage detection circuits capable of detecting a DC voltage. Then, the voltage detection circuit 24 outputs voltage information indicating the measured value of the output voltage to the communication device 25.

The communication device 25 generates a radio signal including the voltage information received from the voltage detection circuit 24 for each predetermined transmission cycle, and transmits the radio signal to the communication device 16 of the power transmission apparatus 2. For this purpose, the communication device 25 includes, for example, a communication circuit that generates a radio signal in accordance with a predetermined radio communication standard, and an antenna that outputs the radio signal. The predetermined radio communication standard may be, for example, ISO/IEC 15693, ZigBee (registered trademark), or Bluetooth (registered trademark), similarly to the predetermined radio communication standard of the communication device 16.

Hereinafter, the relationship between the size of the transmission coil 14 of the power transmission apparatus 2, the size of the reception coil 21 of the power reception apparatus 3, and the degree of coupling between the transmission coil 14 and the reception coil 21 will be described.

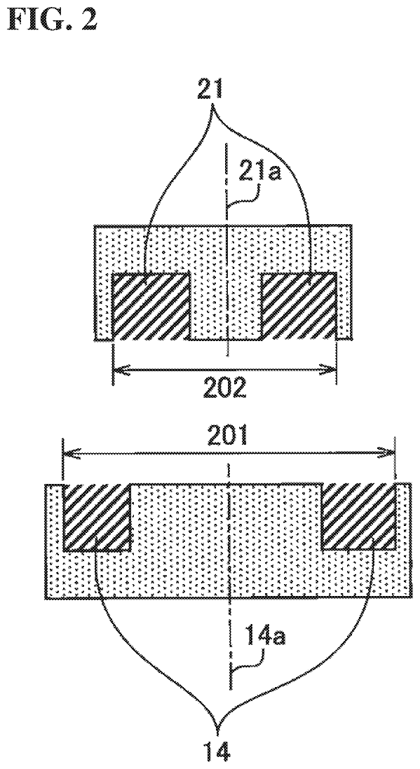

FIG. 2 is a schematic side view of the transmission coil 14 and the reception coil 21, showing a comparison of the size of the transmission coil 14 and the size of the reception coil 21. In the present embodiment, the transmission coil 14 and the reception coil 21 are formed such that the size of the transmission coil 14 (i.e., the outer diameter of the transmission coil 14 indicated by the arrow 201) in a plane orthogonal to a winding axis 14a of the transmission coil 14 is larger than the size of the reception coil 21 (i.e., the outer diameter of the reception coil 21 indicated by the arrow 202) in a plane orthogonal to a winding axis 21a of the reception coil 21. With this configuration, when the positional relationship between the transmission coil 14 and the reception coil 21 changes, a change in the amount of interlinkage flux that is emitted from the transmission coil 14 and passes through the reception coil 21 is suppressed, and thus a change in the degree of coupling between the transmission coil 14 and the reception coil 21 is also suppressed.

In the present embodiment, the winding wire of the transmission coil 14 is wound around a core having a substantially tubular magnetic core centered on the winding axis thereof, and the transmission coil 14 is formed in a substantially tubular shape. Similarly, the winding wire of the reception coil 21 is wound around a core having a substantially tubular magnetic core centered on the winding axis thereof, and the reception coil 21 is formed in a substantially tubular shape. However, the shape of the transmission coil 14 and the shape of the reception coil 21 are not limited to the above examples. The winding wire of the transmission coil 14 may also be wound, for example, around a core having a substantially rectangular magnetic core centered on the winding axis, and the transmission coil 14 may also be formed in a substantially quadrangular prism shape. Similarly, the winding wire of the reception coil 21 may also be wound around a core having a substantially rectangular magnetic core centered on the winding axis, and the reception coil 21 may also be formed in a substantially quadrangular prism shape. Furthermore, the outer diameter of the transmission coil 14 and the outer diameter of the reception coil 21 may also be different from each other.

The transmission coil 14 may also be formed in a substantially tubular shape, while the reception coil 21 may also be formed in a substantially quadrangular prism shape, for example. Furthermore, the core around which the winding wire of the transmission coil 14 is wound and the core around which the winding wire of the reception coil 21 is wound may also be a core having no magnetic core. Alternatively, the magnetic core around which the winding wire of the transmission coil 14 is wound and the magnetic core around which the winding wire of the reception coil 21 is wound may also be formed in a hollow shape. Also, the core around which the winding wire of the transmission coil 14 is wound and the core around which the winding wire of the reception coil 21 is wound may not have an outer shell covering the winding wire.

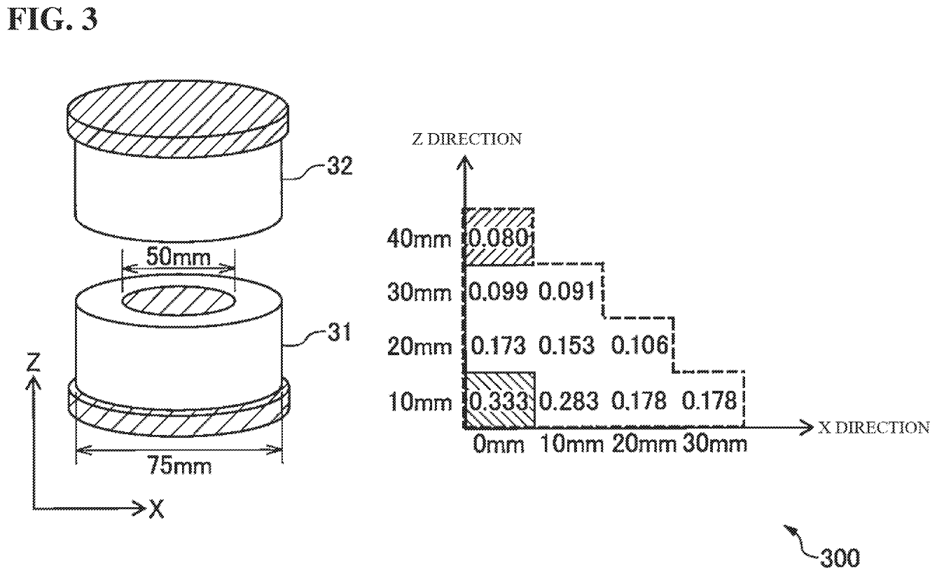

FIG. 3 is a diagram illustrating an example of the relationship between a relative position of the reception coil 32 with respect to the transmission coil 31 and the degree of coupling between the transmission coil 31 and the reception coil 32 according to a comparative example. In this comparative example, the inner diameter and the outer diameter of the transmission coil 31 in the plane orthogonal to the winding axis of the transmission coil 31 are respectively equal to the inner diameter and the outer diameter of the reception coil 32 in the plane orthogonal to the winding axis of the reception coil 32. That is to say, the inner diameter of the transmission coil 31 and the inner diameter of the reception coil 32 are both 25 mm, and the outer diameter of the transmission coil 31 and the outer diameter of the reception coil 32 are both 50 mm. The transmission coil 31 and the reception coil 32 are disposed such that the winding axis of the transmission coil 31 and the winding axis of the reception coil 32 are parallel to each other. For the sake of convenience, an axis in a direction parallel to the winding axis of the transmission coil 31 is defined as a z-axis, and an axis in any one direction in a plane orthogonal to the z-axis is defined as an x-axis.

In FIG. 3, the distribution diagram 300 represents the degree of coupling between the transmission coil 31 and the reception coil 32 with respect to the relative position of the reception coil 32 with respect to the transmission coil 31, obtained by simulation. In the distribution diagram 300, the horizontal axis represents the deviation amount between the winding axis of the transmission coil 31 and the winding axis of the reception coil 32 in the x-axis direction, and the vertical axis represents the distance between the transmission coil 31 and the reception coil 32 in the z-axis direction. In addition, the numerical values shown in the individual columns of the distribution diagram 300 represent the degree of coupling between the transmission coil 31 and the reception coil 32, with respect to the combination of the deviation amount between the winding axes in the corresponding x-axis direction and the distance between the transmission coil 31 and the reception coil 32 in the corresponding z-axis direction. In this simulation, the distance between the transmission coil 31 and the reception coil 32 along the z-axis direction was changed in steps of 10 mm over a range of 10 mm to 40 mm, and the distance between the winding axis of the transmission coil 31 and the winding axis of the reception coil 32 along the x-axis direction was changed in steps of 10 mm over a range of 0 mm to 30 mm.

In this simulation, when the distance between the transmission coil 31 and the reception coil 32 along the z-axis direction is 40 mm and the distance between the winding axes of the transmission coil 31 and the reception coil 32 along the x-axis direction is 0 mm, the degree of coupling k between the transmission coil 31 and the reception coil 32 is at the minimum (0.080). On the other hand, when the distance between the transmission coil 31 and the reception coil 32 along the z-axis direction is 10 mm and the distance between the winding axes of the transmission coil 31 and the reception coil 32 along the x-axis direction is 0 mm, the degree of coupling k between the transmission coil 31 and the reception coil 32 is at the maximum (0.333). Therefore, the degree of coupling k varies about 4 times at the maximum.

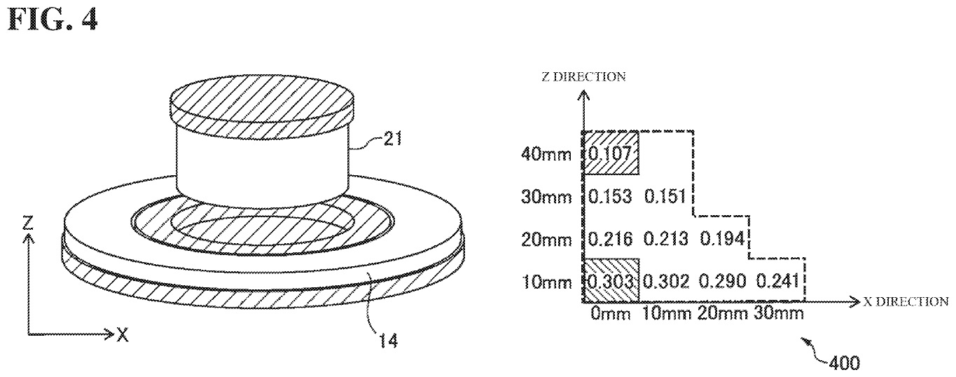

FIG. 4 is a diagram illustrating an example of the relationship between a relative position of the reception coil 21 with respect to the transmission coil 14 and the degree of coupling between the transmission coil 14 and the reception coil 21 according to the present embodiment. In this example, the inner diameter and the outer diameter of the transmission coil 14 are respectively 70 mm and 110 mm, and the inner diameter and the outer diameter of the reception coil 21 are respectively 25 mm and 50 mm. That is to say, the outer diameter of the reception coil 21 is smaller than the inner diameter of the transmission coil 14. In this simulation, the winding wire of the transmission coil 14 is wound around a core having a recessed center when viewed from the reception coil 21 side. The inductance of the transmission coil 14 was the same as the inductance of the transmission coil 31 in the simulation shown in FIG. 3. The inductance of the reception coil 21 was the same as the inductance of the reception coil 32 in the simulation shown in FIG. 3. Also in this simulation, the transmission coil 14 and the reception coil 21 are disposed such that the winding axis of the transmission coil 14 and the winding axis of the reception coil 21 are parallel to each other. In addition, similarly to FIG. 3, the axis in the direction parallel to the winding axis of the transmission coil 14 is defined as the z-axis, and the axis in any one direction in a plane orthogonal to the z-axis is defined as the x-axis.

In FIG. 4, the distribution diagram 400 represents the degree of coupling between the transmission coil 14 and the reception coil 21 with respect to the relative position of the reception coil 21 with respect to the transmission coil 14, obtained by simulation. In the distribution diagram 400, the horizontal axis represents the deviation amount between the winding axis of the transmission coil 14 and the winding axis of the reception coil 21 in the x-axis direction, and the vertical axis represents the distance between the transmission coil 14 and the reception coil 21 in the z-axis direction. In addition, the numerical values shown in the individual columns of the distribution diagram 400 represent the degree of coupling between the transmission coil 14 and the reception coil 21, with respect to the combination of the deviation amount between the winding axes in the corresponding x-axis direction and the distance between the transmission coil 14 and the reception coil 21 in the corresponding z-axis direction. Also in this simulation, the distance between the transmission coil 14 and the reception coil 21 along the z-axis direction was changed in steps of 10 mm over a range of 10 mm to 40 mm, and the distance between the winding axis of the transmission coil 14 and the winding axis of the reception coil 21 along the x-axis direction was changed in steps of 10 mm over a range of 0 mm to 30 mm.

In this simulation, when the distance between the transmission coil 14 and the reception coil 21 along the z-axis direction is 40 mm and the distance between the winding axes of the transmission coil 14 and the reception coil 21 along the x-axis direction is 0 mm, the degree of coupling k between the transmission coil 14 and the reception coil 21 is at the minimum (0.107). On the other hand, when the distance between the transmission coil 14 and the reception coil 21 along the z-axis direction is 10 mm and the distance between the winding axes of the transmission coil 14 and the reception coil 21 along the x-axis direction is 0 mm, the degree of coupling k between the transmission coil 14 and the reception coil 21 is at the maximum (0.303). Therefore, it can be seen that the degree of coupling k varies about 3 times at the maximum, and the variation range of the degree of coupling is reduced to about ¾ compared to the comparative example.

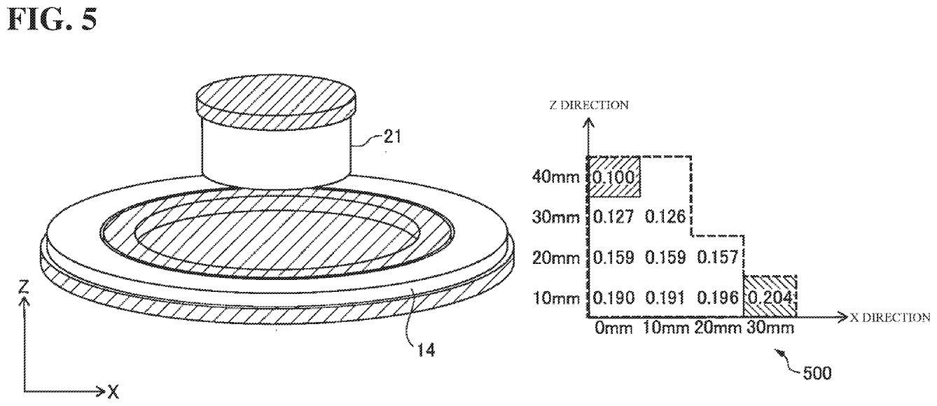

FIG. 5 is a diagram illustrating another example of the relationship between a relative position of the reception coil 21 with respect to the transmission coil 14 and the degree of coupling between the transmission coil 14 and the reception coil 21 according to the present embodiment. In this example, the inner diameter and the outer diameter of the transmission coil 14 are respectively 110 mm and 150 mm, and the inner diameter and the outer diameter of the reception coil 21 are respectively 25 mm and 50 mm. That is to say, the outer diameter of the reception coil 21 is less than half the inner diameter of the transmission coil 14. Also in this simulation, the winding wire of the transmission coil 14 is wound around a core having a recessed center when viewed from the reception coil 21 side. The inductance of the transmission coil 14 was the same as the inductance of the transmission coil 14 in the simulation shown in FIG. 4. The inductance of the reception coil 21 was the same as the inductance of the reception coil 21 in the simulation shown in FIG. 4. Also in this simulation, the transmission coil 14 and the reception coil 21 are disposed such that the winding axis of the transmission coil 14 and the winding axis of the reception coil 21 are parallel to each other. In addition, similarly to FIG. 3 and FIG. 4, an axis in the direction parallel to the winding axis of the transmission coil 14 is defined as the z-axis, and an axis in any one direction in a plane orthogonal to the z-axis is defined as the x-axis.

In FIG. 5, the distribution diagram 500 represents the degree of coupling between the transmission coil 14 and the reception coil 21 with respect to the relative position of the reception coil 21 with respect to the transmission coil 14, obtained by simulation. In the distribution diagram 500, the horizontal axis represents the deviation amount between the winding axis of the transmission coil 14 and the winding axis of reception coil 21 in the x-axis direction, and the vertical axis represents the distance between the transmission coil 14 and the reception coil 21 in the z-axis direction. In addition, the numerical values shown in the individual columns of the distribution diagram 500 represent the degree of coupling between the transmission coil 14 and the reception coil 21, with respect to the combination of the deviation amount between the winding axes in the corresponding x-axis direction and the distance between the transmission coil 14 and the reception coil 21 in the corresponding z-axis direction. Also in this simulation, the distance between the transmission coil 14 and the reception coil 21 along the z-axis direction was changed in steps of 10 mm over a range of 10 mm to 40 mm, and the distance between the winding axis of the transmission coil 14 and the winding axis of the reception coil 21 along the x-axis direction was changed in steps of 10 mm over a range of 0 mm to 30 mm.

In this simulation, when the distance between the transmission coil 14 and the reception coil 21 along the z-axis direction is 40 mm and the distance between the winding axes of the transmission coil 14 and the reception coil 21 along the x-axis direction is 0 mm, the degree of coupling k between the transmission coil 14 and the reception coil 21 is at the minimum (0.100). On the other hand, when the distance between the transmission coil 14 and the reception coil 21 along the z-axis direction is 10 mm and the distance between the winding axes of the transmission coil 14 and the reception coil 21 along the x-axis direction is 30 mm, the degree of coupling k between the transmission coil 14 and the reception coil 21 is at the maximum (0.204). Therefore, it can be seen that the degree of coupling k varies about twice at the maximum, and the variation range of the degree of coupling is reduced to about half compared to the comparative example. Furthermore, it can be seen that the variation range of the degree of coupling k is reduced to about ⅔ as compared with the combination of the outer diameter and the inner diameter of the transmission coil 14 and the outer diameter and the inner diameter of the reception coil 21 in the simulation shown in FIG. 4. Therefore, it can be seen that the variation of the degree of coupling k is further suppressed by making the outer diameter of the reception coil 21 smaller than the inner diameter of the transmission coil 14. In this simulation, when the distance between the transmission coil 14 and the reception coil 21 in the z-axis is 10 mm, the degree of coupling k is higher when the distance between the winding axis of the transmission coil 14 and the winding axis of the reception coil 21 along the x-axis is 30 mm than when the distance between the axes is 0 mm. The reason for this is that the reception coil 21 is closer to the winding wire of the transmission coil 14 that generates the magnetic flux and the interlinkage flux increases when the distance between the winding axes is 30 mm than when the distance between the winding axes is 0 mm.

As described above, it can be seen that a change in the degree of coupling between the transmission coil 14 and the reception coil 21 due to a change in the position between the transmission coil 14 and the reception coil 21 is suppressed, by making the size of the transmission coil 14 in the plane orthogonal to the winding axis of the transmission coil 14 larger than the size of the reception coil 21 in the plane orthogonal to the winding axis of the reception coil 21. Furthermore, it is easy to reduce the size of the entire power reception apparatus 3, by making the reception coil 21 smaller than the transmission coil 14.

As described above, in the non-contact power feeding apparatus, the transmission coil and the reception coil are formed such that the size of the transmission coil in the plane orthogonal to the winding axis of the transmission coil is larger than the size of the reception coil in the plane orthogonal to the winding axis of the reception coil. For this reason, in the non-contact power feeding apparatus, a change in the amount of interlinkage flux due to a change in the relative positional relationship between the transmission coil and the reception coil is suppressed. As a result, variation in the degree of coupling between the transmission coil and the reception coil due to a change in the relative positional relationship between the transmission coil and the reception coil is also suppressed, and thus variation in the power transmission efficiency is also suppressed. Furthermore, because the variation of the power transmission efficiency is suppressed, the variation of the output voltage from the power reception apparatus is also suppressed in the variation range of the assumed positional relationship between the power transmission apparatus and the power reception apparatus. Accordingly, the non-contact power feeding apparatus can narrow the adjustment range of the voltage of the AC power supplied to the transmission coil. Therefore, in the non-contact power feeding apparatus, it is easy to simplify the configuration of the power transmission apparatus for keeping the output voltage constant.

In a modification, the transmission coil 14 and the reception coil 21 may also be formed such that the size of the reception coil 21 in the plane orthogonal to the winding axis of the reception coil 21 is larger than the size of the transmission coil 14 in the plane orthogonal to the winding axis of the transmission coil 14. In addition, similarly to the above embodiment, it is preferable that the inner diameter of the reception coil 21 in the plane orthogonal to the winding axis of the reception coil 21 is larger than the outer diameter of the transmission coil 14 in the plane orthogonal to the winding axis of the transmission coil 14. Furthermore, it is more preferable that the outer diameter of the transmission coil 14 in the plane orthogonal to the winding axis of the transmission coil 14 is equal to or less than half of the inner diameter of the reception coil 21 in the plane orthogonal to the winding axis of the reception coil 21.

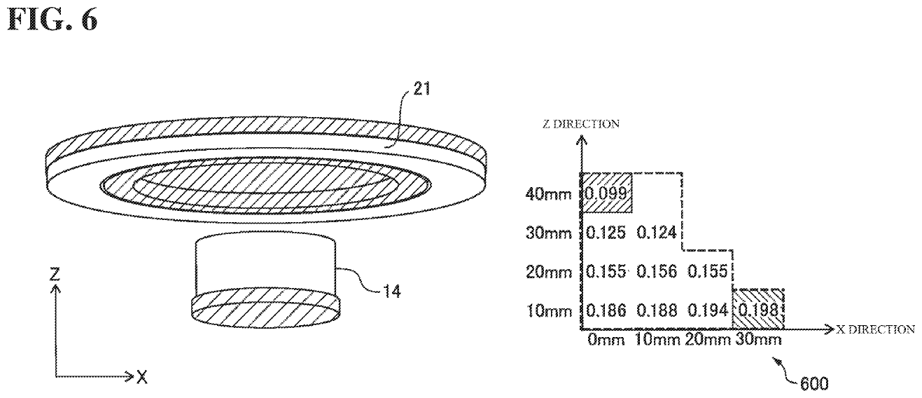

FIG. 6 is a diagram illustrating an example of the relationship between a relative position of the reception coil 21 with respect to the transmission coil 14 and the degree of coupling between the transmission coil 14 and the reception coil 21 according to the modification. In this example, the inner diameter and the outer diameter of the transmission coil 14 are respectively 25 mm and 50 mm, and the inner diameter and the outer diameter of the reception coil 21 are respectively 110 mm and 150 mm. That is to say, the outer diameter of the transmission coil 14 is less than half the inner diameter of the reception coil 21. Also in this simulation, the winding wire of the reception coil 21 is wound around a core having a recessed center when viewed from the transmission coil 14 side. The inductance of the transmission coil 14 was the same as the inductance of the transmission coil 14 in the simulations shown in FIGS. 4 and 5. The inductance of the reception coil 21 was the same as the inductance of the reception coil 21 in the simulations shown in FIGS. 4 and 5. Also in this simulation, the transmission coil 14 and the reception coil 21 are disposed such that the winding axis of the transmission coil 14 and the winding axis of the reception coil 21 are parallel to each other. In addition, similarly to FIG. 3 to FIG. 5, an axis in the direction parallel to the winding axis of the transmission coil 14 is defined as the z-axis, and an axis in any one direction in a plane orthogonal to the z-axis is defined as the x-axis.

In FIG. 6, the distribution diagram 600 represents the degree of coupling between the transmission coil 14 and the reception coil 21 with respect to the relative position of the reception coil 21 with respect to the transmission coil 14, obtained by simulation. In the distribution diagram 600, the horizontal axis represents the deviation amount between the winding axis of the transmission coil 14 and the winding axis of reception coil 21 in the x-axis direction, and the vertical axis represents the distance between the transmission coil 14 and the reception coil 21 in the z-axis direction. In addition, the numerical values shown in the individual columns of the distribution diagram 600 represent the degree of coupling between the transmission coil 14 and the reception coil 21, with respect to the combination of the deviation amount between the winding axes in the corresponding x-axis direction and the distance between the transmission coil 14 and the reception coil 21 in the corresponding z-axis direction. Also in this simulation, the distance between the transmission coil 14 and the reception coil 21 along the z-axis direction was changed in steps of 10 mm over a range of 10 mm to 40 mm, and the distance between the winding axis of the transmission coil 14 and the winding axis of the reception coil 21 along the x-axis direction was changed in steps of 10 mm over a range of 0 mm to 30 mm.

In this simulation, when the distance between the transmission coil 14 and the reception coil 21 along the z-axis direction is 40 mm and the distance between the winding axes of the transmission coil 14 and the reception coil 21 along the x-axis direction is 0 mm, the degree of coupling k between the transmission coil 14 and the reception coil 21 is at the minimum (0.099). On the other hand, when the distance between the transmission coil 14 and the reception coil 21 along the z-axis direction is 10 mm and the distance between the winding axes of the transmission coil 14 and the reception coil 21 along the x-axis direction is 30 mm, the degree of coupling k between the transmission coil 14 and the reception coil 21 is at the maximum (0.198). Therefore, it can be seen that the degree of coupling k varies about twice at the maximum, and the variation range of the degree of coupling is reduced to about half compared to the above comparative example.

In this modification, because the reception coil 21 is relatively large, it is easy to make the inductance of the reception coil 21 larger than the inductance of the transmission coil 14. Then, when the inductance of the reception coil 21 increases, magnetic flux concentrates in the vicinity of the reception coil 21 during power transmission. In such a case, even if the phase adjustment circuit 15 of the power transmission apparatus 2 is not provided, the delay of a phase of a current flowing thorough the switching elements with respect to a phase of a voltage applied to the switching elements of the inverter circuit 13 of the power supply circuit 10 of the power transmission apparatus 2 is suppressed. Therefore, in this modification, the phase adjustment circuit 15 may also be omitted.

Also in the above embodiment, if the inductance of the reception coil 21 is relatively large, the phase adjustment circuit 15 may also be omitted.

Those skilled in the art can make various modifications while remaining within the scope of the of the disclosed and recited embodiments.

1. A non-contact power feeding apparatus comprising:
a power transmission apparatus; and
a power reception apparatus to which power is transmitted from the power transmission apparatus in a non-contact manner, wherein
the power transmission apparatus comprises:
a transmission coil configured to supply AC power to the power reception apparatus; and
a power supply circuit configured to supply AC power to the transmission coil, and
the power reception apparatus comprises a resonance circuit including a reception coil configured to receive AC power from the transmission coil, and
the transmission coil and the reception coil are formed such that the size of one of: the transmission coil; and the reception coil, in a plane orthogonal to a winding axis thereof is larger than the size of the other of: the transmission coil; and the reception coil, in a plane orthogonal to a winding axis thereof.

2. The non-contact power feeding apparatus according to claim 1, wherein the transmission coil and the reception coil are formed such that an inner diameter of the one coil in the plane orthogonal to the winding axis thereof is larger than an outer diameter of the other coil in the plane orthogonal to the winding axis thereof.

3. The non-contact power feeding apparatus according to claim 1, wherein
the power supply circuit of the power transmission apparatus comprises an inverter circuit including a plurality of switching elements connected in a full-bridge configuration or a half-bridge configuration between a DC power supply and the transmission coil, and the power supply circuit is configured to convert DC power supplied from the DC power supply into AC power having a frequency at which the resonance circuit of the power reception apparatus resonates by switching on and off of the plurality of switching elements at that frequency, and supplies the AC power to the transmission coil, and
the power transmission apparatus further comprises a phase adjustment circuit configured to adjust a delay amount of a phase of a current flowing through the plurality of switching elements of the inverter circuit with respect to a phase of a voltage applied to the plurality of switching elements.

4. The non-contact power feeding apparatus according to claim 2, wherein
the power supply circuit of the power transmission apparatus comprises an inverter circuit including a plurality of switching elements connected in a full-bridge configuration or a half-bridge configuration between a DC power supply and the transmission coil, and the power supply circuit is configured to convert DC power supplied from the DC power supply into AC power having a frequency at which the resonance circuit of the power reception apparatus resonates by switching on and off of the plurality of switching elements at that frequency, and supplies the AC power to the transmission coil, and
the power transmission apparatus further comprises a phase adjustment circuit configured to adjust a delay amount of a phase of a current flowing through the plurality of switching elements of the inverter circuit with respect to a phase of a voltage applied to the plurality of switching elements.
